(19) United States
(12) Patent Application Publication
(10) Pub. No.: US 2015/0184037 A1
(43) Pub. Date: Jul. 2, 2015

(54) Overlaminate Film

(71) Applicant: Avery Dennison Corporation, Glendale, CA (US)

(72) Inventors: Osei OWUSU, Concord Township, OH (US); Shanshan WANG, Mentor, OH (US); Bernard S. MIENTUS, Painesville, OH (US)

(21) Appl. No.: 14/568,752

(22) Filed: Dec. 12, 2014

Related U.S. Application Data
(60) Provisional application No. 61/921,571, filed on Dec. 30, 2013.

(51) Int. Cl. C09J 7/02

(52) U.S. Cl. CPC C09J 7/0296; C09J 7/0278; C09J 7/0271; C09J 2201/122; C09J 2201/162; C09J 2201/36; C09J 2431/006; C09J 2423/006

(57) ABSTRACT

Overlaminate films and methods of their manufacture and use are disclosed.

### CROSS-REFERENCE TO RELATED APPLICATION

The present application claims the benefit of U.S. Provisional Application No. 61/921,571 filed on Dec. 30, 2013, which is incorporated herein by reference in its entirety.

### BACKGROUND OF THE INVENTION

Overlaminates may be placed over various materials, such as printing materials, to protect the underlying material from damage. In some instances, overlaminates may be placed over signs and banners having text or graphics, such as for advertising and decorations. The present invention includes overlaminates for these purposes and any other suitable purposes.

### SUMMARY OF THE INVENTION

In one embodiment, the invention includes an overlaminate film. The overlaminate film may include a skin layer comprising an abrasion resistant material, a core layer comprising a blend of one or more semicrystalline polymer and ethylene vinyl acetate, and an adhesive layer. In addition, the core layer may be positioned between the skin layer and the adhesive layer.

In another embodiment, the invention includes an overlaminate film. The overlaminate film may include a skin layer comprising an abrasion resistant material and an adhesive layer. In addition, the overlaminate film may include a core layer that includes a blend of (i) one or more of an amorphous olefin copolymer having either a glass transition temperature (Tg) in the range of about 20° C. to about 70° C. (including each intermittent value therein), or a semicrystalline olefin copolymers having a melting point in the range of about 20° C. to about 70° C. including each intermittent value therein), and (ii) a polyolefin. The core layer may be positioned between the skin layer and the adhesive layer.

The following description illustrates one or more embodiments of the invention and serves to explain the principles and exemplary embodiment of the invention.

### BRIEF DESCRIPTION OF THE DRAWINGS

FIG. 1 depicts an embodiment of an overlaminate film of the present invention;

FIG. 2 depicts an additional embodiment of an overlaminate film of the present invention;

FIG. 3 depicts an additional embodiment of an overlaminate film of the present invention;

FIG. 4 depicts an embodiment of an overlaminate film of the present invention as applied to a print layer;

FIG. 5 depicts overlapping segments of two pieces of overlaminated print layers a on substrate;

FIG. 6 is a DMA curve for samples evaluated;

FIG. 7 is a graph comparing optical properties of samples tested;

FIG. 8 is a graph of modulus data for samples tested;

FIG. 9 is an illustrative image of a film exhibiting tunneling effects; and

FIG. 10 is a flow chart illustrating films orientation at overlapping area as referenced herein.

### DETAILED DESCRIPTION OF EXEMPLARY EMBODIMENTS

Reference will now be made in detail to exemplary embodiments of the present invention, one or more examples of which are illustrated in the accompanying drawings. Each example is provided by way of explanation of the invention and not by limitation of the invention. It will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents. In addition, the use of reference characters with the same two ending digits as other reference characters to indicate structure in the present specification and drawings, without a specific discussion of such structure, is intended to represent the same or analogous structure in different embodiments. Unless otherwise indicated herein, all percentages used for a component refer to the percentage by weight.

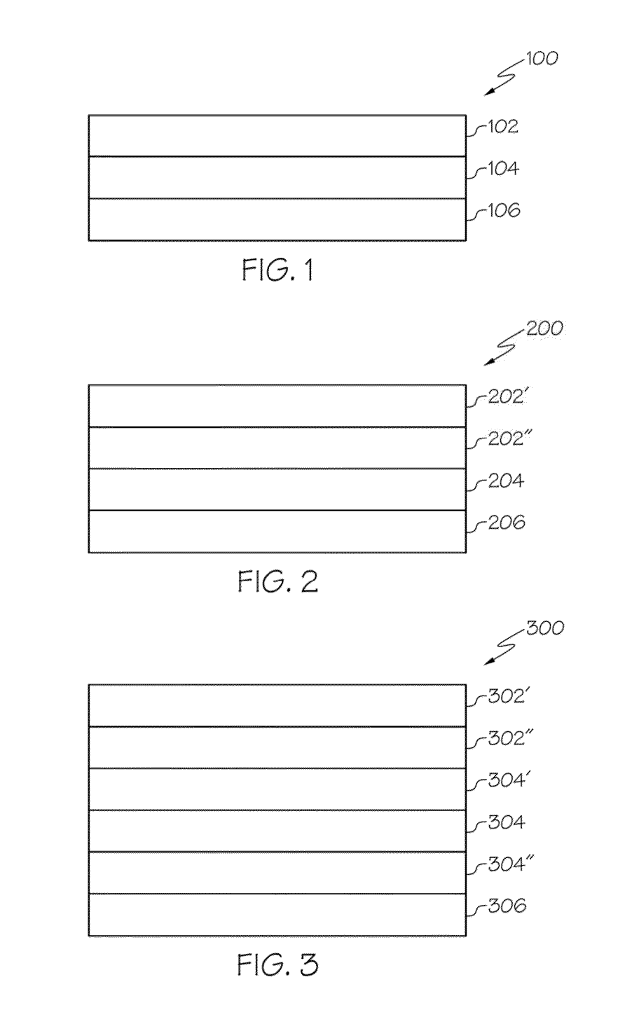

In some embodiments, the present invention includes a film overlaminate. In some embodiments, such overlaminates may include at least one skin layer that is an abrasion resistance layer, at lease one core layer, and at least one skin layer referenced as an adhesive layer. By way of example to an illustrative embodiment, FIG. 1 shows an overlaminate 100 having a skin layer 102, a core layer 104, and an adhesive layer 106. In some embodiments, a film may have multiple skin layers and/or multiple core layers. In still other embodiments, films of the present invention may include additional layers.

As indicated above, one or more skin layers of the overlaminate may include an abrasion resistance layer. Such abrasion resistant layers may be comprised of any suitable abrasion resistant material. For example, in some embodiments, an abrasion resistance layer may include Surlyn products available from DuPont, including Surlyn 1803. Other suitable abrasion resistant materials that form or be included in the abrasion resistance layer include ethylene acrylic polymers and copolymers. In other embodiments, other suitable materials may be used that provide suitable abrasion resistance for a particular application of a film.

In some embodiments, skin layers, including abrasion resistant layers, may also include one or more matting agents (also called gloss reducers), such as DIL 3636 DP20 from A. Schulman Inc and/or Ampacet 400700D from Ampacet Corp. in amount ranging from about 1% to about 50% by weight of the total skin layer. Such matting agents may provide a matte finish to the film.

In some embodiments, skin layers, including abrasion resistant layers, may also include one or more stabilizers, such as the ultraviolet (“UV”) light stabilizer Ampacet UV 10561, which is available from Ampacet Corporation. By way of further example, a skin layer may also include free radical scavengers. Free radical scavengers, such as hindered amine light stabilizer (HALS), may be present, alone or in addition to UV light stabilizers, in an amount of about 0.05 to about two weight percent per layer, and the UV light stabilizers, such as benzophenone, can be present in amounts ranging from 0.1 to about 5 weight percent per layer. Such ultraviolet light stabilizers and/or free radical scavengers may be included in some or all of the skin layers of a particular embodiment.

In addition, one or more skin layers of the present invention may also include and one or more process aids, such as Ampacet 10919 available from Ampacet Corporation. Furthermore, in some embodiments, one or more skin layers may include a flame retardant compound. By way of example, such a flame retardant may include FRC-2005 (which is a flame retardant and ultraviolet stabilizer that is available from Polyfil Corporation).

Similarly, one or more skin layers of the present invention may also or alternatively include heat stabilizers. Heat stabilizers may include Ferro 1237, Ferro 1720, and Synpron 1163, all available from Ferro Corporation Polymer Additives Division, and Mark V 1923, available from Witco Corp. By way of example, heat stabilizers may be present in an amount from about 0.2 to about 0.15 percent by total weight of a print layer, including each intermittent value therein. In embodiments having multiple skin layers, such heat stabilizers may be included in some or all of the skin layers.

In some embodiments of the present invention, an overlaminate may include at least two skin layers. In addition, some embodiments may include at least two skin layers that are abrasion resistant layers. Other embodiments may have more than two skin layers, wherein some or all of such additional skin layers may optionally be abrasion resistant layers. In addition, as set forth herein, some embodiments may also include a top coating.

Laminates of the present invention may also include at least one core layer. As shown in FIG. 1 and described above, a core layer may be positioned in the laminate between the abrasion resistance layer and the adhesive layer. In one embodiment, at least one layer of a core layer comprises a blend of (i) one or more semicrystalline polymers, and (ii) ethylene vinyl acetate. Suitable semicrystalline polymers may include, by way of example, semicrystalline polymers such as polyethylene. In one embodiment of the present invention, the core layer may include a blend of medium density polyethylene and ethylene vinyl acetate. In another embodiment, the core layer may include a blend of high density polyethylene and ethylene vinyl acetate. In still other embodiments, the core layer may include a blend of medium density polyethylene, high density polyethylene, and ethylene vinyl acetate. The desired stiffness of a film may be controlled, at least in part, by the type and amount of polymer included. For example, high density polyethylene results in increased stiffness of the film at room temperature as compared with medium density polyethylene. In certain embodiments of the present invention, core layers may comprise from about 5% to about 95% by weight semicrystalline polymers and about 5% to about 95% by weight ethylene vinyl acetate. In some embodiments, a core layer may comprise at least about 13% by weight ethylene vinyl acetate.

In still other embodiments, other suitable compositions may be used for one or more layers of a core layer. For example, in one particular embodiment, a core layer may be formed from or comprised of a blend of (i) an amorphous olefin copolymer having a glass transition temperature (Tg) in the range of about 20° C. to about 70° C. (including each intermittent value therein), and/or a semicrystalline olefin copolymer having a melting point in the range of about 20° C. to about 70° C. (including each intermittent value therein), and (ii) a polyolefin, such as, for example, polypropylene. Any suitable amorphous olefin copolymer may be used. For example, in some embodiments, cyclic olefin copolymers (COC), such as Topas 9903 D-10 with a Tg of 33° C., which is available from TOPAS Advanced Polymers, may be used as a suitable amorphous olefin copolymer. For example, in some embodiments, ethylene polypropylene copolymer, such as Versify 2300 melting temperature of 66° C., which is available from Dow Chemical, may be used as suitable semicrystalline olefin copolymer. Such layers—comprised of a blend of (i) an amorphous olefin copolymer having either a glass transition temperature (Tg) in the range of about 20° C. to about 70° C. (including each intermittent value therein), and/or a semicrystalline olefin copolymer having a melting point in the range of about 20° C. to about 70° C. including each intermittent value therein), and (ii) a polyolefin—may comprise the entire core layer, one layer of a multilayer core layer, or multiple or all layers of a multilayer core layer. By way of example, in certain embodiments of the present invention, core layers may comprise about 5 to about 100 percent by weight of an amorphous olefin copolymer and about 0 to about 95 percent by weight polyolefin. In some embodiments, core layers may comprise at least about 20 percent by weight of an amorphous olefin copolymer.

Core layers of the present invention may also include other components. For example, some or all layers of a core layer may include one or more ultraviolet light stabilizers, one or more free radical scavengers, one or more process aids, one or more heat stabilizers, and/or one or more flame retardants. Such components may be included a core layer as described above with respect to the skin layers.

In some embodiments of the present invention, a core layer may have multiple layers. For example, in some embodiments, a multilayer core layer may have three layers, such as a first core layer, a second core layer, and a third core layer. By way of example, a second core layer of a multilayer core layer may be located between a skin layer, such as an abrasion resistance layer, and a first core layer, and a third core layer of a multilayer core layer may be located between the first core layer and the adhesive layer. The second core layer and the third core layer may each have the same composition of the first core layer in some embodiments, and in other embodiments the second core layer and/or the third core layer may have distinct compositions from the first core layer. In some embodiments, the second core layer and/or the third core layer may be less thick than the first core layer and/or may (each or collectively) constitute a lesser weight percentage of a film than the core layer.

For example, in one embodiment, the middle layer of a three-layer core layer may be a blend of medium density polyethylene with ethylene vinyl acetate, and the outer layers of the three-layer core layer may be a blend of blend of high density polyethylene and ethylene vinyl acetate. In still other embodiments, a multi-layer core layer may have multiple adjacent layers having the same composition as a central layer of the core layer.

Using film compositions as described herein, certain overlaminate embodiments of the present invention may be suitably rigid at room temperature for handling purposes. In addition, certain overlaminate embodiments of the present invention may provide sufficient structural behavior such that at increased temperatures tunneling does not substantially occur or does not occur, as described in more detail herein.

As indicated above, overlaminates of the present invention may also include an adhesive layer. Such adhesive layers may provide a surface to which any suitable adhesive may be added and may comprise any suitable material. In some embodiments, an adhesive layer may include a polymer resin, such as a low density olefin homopolymer resin. For example, Petrothene NA 324-009, available from LyondellBasell, and/or a low density or linear low density polyethylene, such as Dowlex 2036G available from The Dow Chemical Company, may be used to form an adhesive layer in some embodiments of the present invention. The adhesive layer may also include ethylene vinyl acetate. In some embodiments, the adhesive layer may also include stabilizers, such as the ultraviolet light stabilizer Ampacet UV 10561 (available from Amapcet Corporation) and/or FR-2005 (which is a flame retardant and ultraviolet stabilizer and available from Polyfil Corporation). In addition, an adhesive layer may include one or more process aids, such as Ampacet 10919. The adhesive layer may also include heat stabilizers, ultraviolet light stabilizers, and free radical scavengers as discussed above. In some embodiments, adhesive, such as a pressure sensitive adhesive, may be applied to an adhesive layer and a release liner may optionally be located adjacent to an adhesive layer, such that the release layer is suitable for removal prior to and at the time of application of the overlaminate.

Overlaminates of the present invention may be used with any suitable underlying material, such as to protect an underlying print film. A pressure sensitive adhesive may be used between the overlaminate and the underlying print film. The pressure sensitive adhesive may adhere to the adhesive layer of the overlaminate. Prior to application of the overlaminate to a print film, the overlaminate may have a releasable liner adjacent to the adhesive.

In some embodiments, overlaminates of the present invention may be substantially free of polyvinyl chloride (PVC). In other embodiments, overlaminates of the present invention may not include any PVC. In some embodiments, such substantially PVC-free or PVC-free overlaminates may be used as an overlaminate on an underlying material that does is either free or substantially free of PVC. In some embodiments, by way of example, overlaminates of the present invention may be used on an underlying material such as True Impact TMP7000 materials, available from Avery Dennison Corporation.

In one embodiment, as shown in FIG. 2, an overlaminate 200 may include a first skin layer 202′ and a second skin layer 202″, wherein one or both may be an abrasion resistant layer, a core layer 204, and an adhesive layer 206. In an alternative embodiment, as shown in FIG. 3, an overlaminate 300 may include a first skin layer 302′ and a second skin layer 302″, wherein one or both may be an abrasion resistant layer, a three-layer core layer including a first core layer 304, a second core layer 304′, and third core layer 304″, and an adhesive layer 306. As explained above, some embodiments may also include an adhesive (not shown) in contact with adhesive layer 306 and, optionally, a release liner (not shown) in contact with the adhesive.

In still other embodiments, an overlaminate of the present invention may include a tie layer positioned between a core layer and a skin layer, such as an abrasion resistance layer. A tie layer may include ethylene vinyl acetate, and, in some embodiments, a tie layer may comprise all or substantially all ethylene vinyl acetate. In some embodiments, a tie layer may also include some or all layers of a core layer may include one or more ultraviolet light stabilizers, one or more free radical scavengers, one or more process aids, one or more heat stabilizers, and/or one or more flame retardants. Such components are described above with respects to the skin layers and may be included in tie layers in the same manner.

In addition, some embodiments of laminates of the present invention may be entirely free of polyvinyl chloride (“PVC”). In other embodiments, laminates of the present invention may be substantially free of polyvinyl chloride. In such embodiments entirely free or substantially free of polyvinyl chloride, laminates of the present invention may offer satisfactorily-similar properties to known polyvinyl chloride laminates.

Overlaminates of the present invention may be suitable for indoor and/or outdoor use. Such overlaminates may provide suitable and desirable durability, scratch resistance, gloss, conformability, tensile elongation and tensile strength for such applications. In addition, overlaminates of the present invention may have a glossy finish or a matte finish.

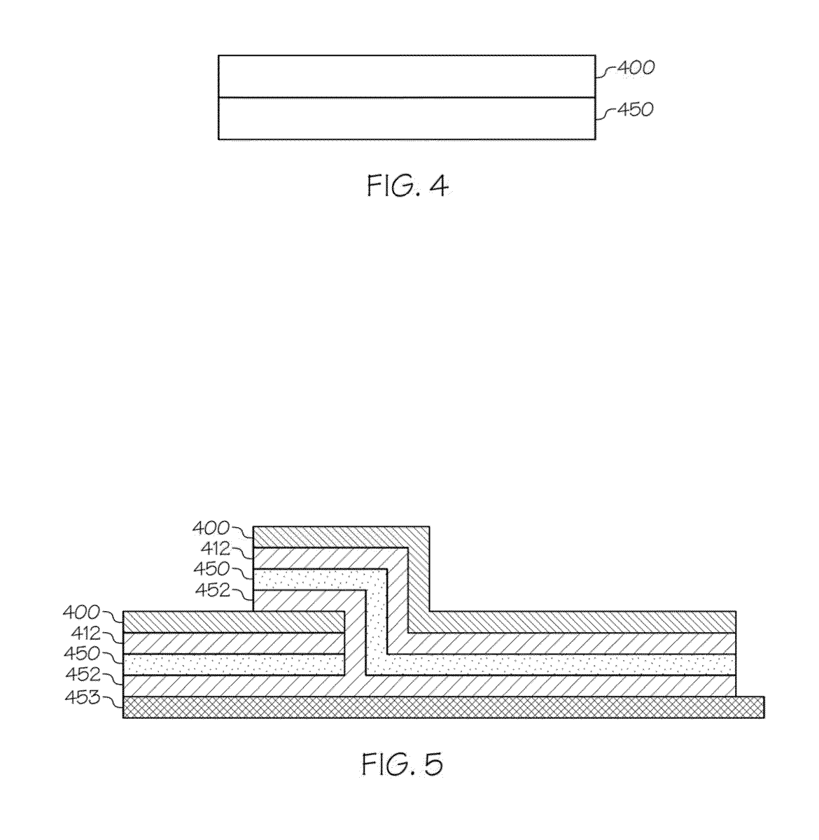

Overlaminates of the present invention may be applied over a print layer, which may include text and graphics such as for advertising or decoration. For example, as shown in FIG. 4, overlaminate 400 may be applied over a print layer 450. A pressure sensitive adhesive may be disposed between overlaminate 400 and print layer 450. In other embodiments, a print layer may be multiple layers and may be of any suitable composition known in the art.

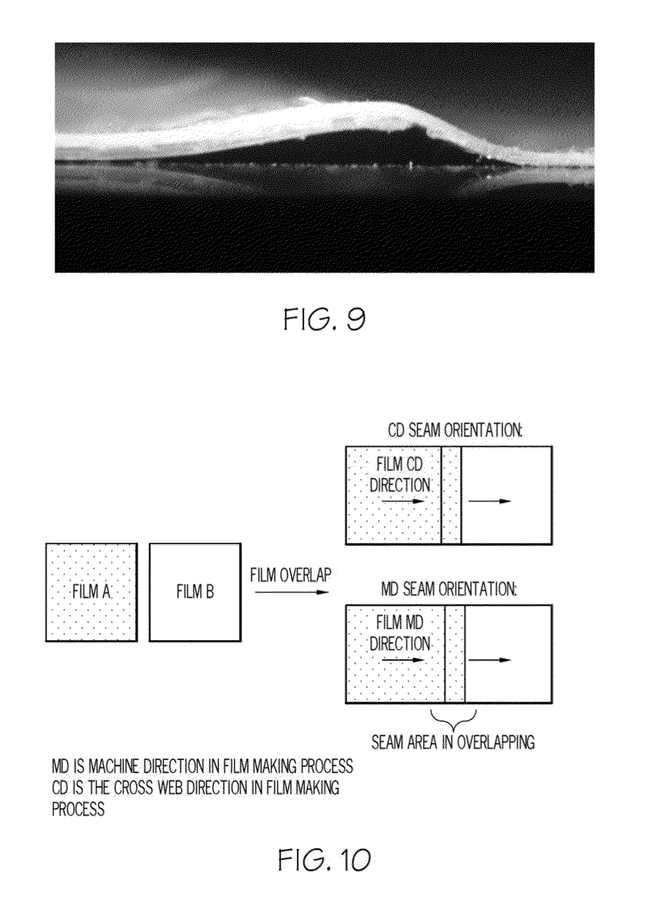

In some embodiments, such as due to the size of large banners or displays, an overlaminated print layer may be provided in segments that overlap to form a single display, such as shown in FIG. 5. For example, as shown in FIG. 5, overlaminate layer 400 (which may, in some embodiments, be a multilayer film as described herein) is affixed to print layer 452 using adhesive 412. As shown, one segment of the overlaminated print layer overlaps with another segment of an overlaminated print layer, and each segment is affixed to substrate 453 using adhesive 452, which may be the same or different as adhesive 412. As such, overlaminate 400 (which may be a multilayer film as described herein) is laid over each segment and affixed to the print layer using adhesive 412. Some such overlapping overlaminates are known to result in “tunneling” when exposed to high temperatures, such as high outdoor temperatures, especially in the summer season. Tunneling indicates a separation or buckling of the overlaminate from the underlying substrate (such as print layer 450), such that a hump or unevenness is formed. An example of tunneling is shown in FIG. 9. In addition, tunneling may also include a separation or lifting of an overlaminate and any underlying substrate from a material to which they are applied. Tunneling may often result from temperature variations and fluctuations. In some embodiments as indicated in the illustrative examples below, overlaminates of the present invention may not tunnel when exposed to temperature variations, such as when used in an outdoor setting. Using certain embodiments of the present invention, tunneling may be diminished or eliminated. In addition, films of the present invention may also provide a sufficiently stiff film at room temperature to render handling by a user satisfactory.

The following examples further illustrate embodiments and features of the invention. The following components may be referenced in these examples:

| Component | Description |
|---|---|
| Surlyn 1803 | Ionomer resins of ethylene copolymers |
| | containing acid groups partially neutralized |
| | using metal salts. Family of ionomers are |
| | partially neutralized by metals such as zinc, |
| | sodium, and others. Other ionomers that can |
| | be used include packaging grade ionomers |
| | such as Surlyn 1705, 1601, 1901, 1857 as well |
| | as golf ball grade 9120. |
| Ampacet Process Aid | Process aid masterbatch in polyethylene |
| | supplied by Ampacet Corporation |
| Ampacet UV 10561 | UV absorber in LDPE, supplied by Ampacet |
| | Corporation |
| Petrothene NA324-009 | Low density homopolymer with density of |
| | 0.931 supplied by Equistar Corporation |
| FRC-2005 | Flame retardant/UV absorber in polyethylene |
| | supplied by Polyfil Corporation |
| Dow DMTA-8904 NT 7 | High density polyethylene with a density of |
| | 0.952 from Dow Chemical |
| Dowlex 2036G | Linear low density polyethylene with density |
| | of 0.935 supplied by Dow Chemical |
| Huntsman LDPE 1017 | Low density polyethylene with density of 9.2 |
| | available from Huntsman Corporation. |
| Topas 9903 D-10 | Cyclo olefin copolymer with a Tg of 33 C. |
| | supplied by Topas Advanced Polymers |
| Topas 9506F-04 | Cyclo olefin copolymer with a Tg of 65 C. |
| | supplied by Topas Advanced Polymers |

### Example 1

A multilayer overlaminate film with an overall thickness of 2.5 mils was produced using a conventional 4-layer cast film co-extrusion process. Each of the four extruders (A, B, C, and D) supplied a melt formulation to a feedblock where the melts were combined to form a single molten stream consisting of four different layers. Extruder A was fed with material that formed a skin layer, also referenced as an abrasion resistant layer, Extruder C was fed with a molten layer that formed the core layer, and Extruder D was fed with the adhesive layer. As reflected in Table I, Extruder B was fed with either the same material as Extruder C that also formed the core layer or, alternatively, material that formed a tie layer. In the resulting films without a tie layer, the skin layer formed about 10% of the overall film thickness, the core layer (from Extruders B and C) formed a total of about 80% of the overall film thickness, and the adhesive layer formed about 10% of the overall film thickness. In the resulting films with a tie layer, the skin layer formed about 10% of the overall film thickness, the tie layer formed about 10% of the overall film thickness, the core layer formed about 70% of the overall film thickness, and the adhesive layer formed about 10% of the overall film thickness. For each sample, the molten stream was cast onto a cast roll with a chrome finish and an airknife at 60 Hz was used to pin the quenched film to the chrome roll. Table I shows the formulations used in the different extruders, wherein the percentages are by weight.

TABLE I

| | Skin Layer | Tie Layer | Core Layer | Adhesive Layer |
|---|---|---|---|---|
| Sample | (10%) | (10% if present) | (70% or 80%) | (10%) |
| 1 | 93% Surlyn 1803 | None | 73% Petrothene | 62% Petrothene |
| | 5% Ampacet UV | | NA324-009 | NA324-009 |
| | 2% Ampacet | | 25% Ethylene vinyl | 35% Ethylene vinyl |
| | Process Aid | | acetate | acetate |
| | | | 1% Ampacet UV | 1% Ampacet UV |
| | | | 10561 | 10561 |
| | | | 1% Ampacet | 2% Ampacet |
| | | | Process aid | Process aid 10919 |
| 2 | 93% Surlyn 1803 | None | 98% Petrothene | 62% Petrothene |
| | 5% Ampacet UV | | NA324-009 | NA324-009 |
| | 2% Ampacet | | 1% Ampacet UV | 35% Ethylene vinyl |
| | Process Aid | | 10561 | acetate |
| | | | 1% Ampacet | 1% Ampacet UV |
| | | | Process aid | 10561 |
| | | | | 2% Ampacet |
| | | | | Process aid 10919 |
| 3 | 93% Surlyn 1803 | 93% Ethylene vinyl | 98% Petrothene | 62% Petrothene |
| | 5% Ampacet UV | acetate | NA324-009 | NA324-009 |
| | 2% Ampacet | 5% Ampacet UV | 1% Ampacet UV | 35% Ethylene vinyl |
| | Process Aid | 2% Ampacet | 10561 | acetate |
| | | Process Aid | 1% Ampacet | 1% Ampacet UV |
| | | | Process aid | 10561 |
| | | | | 2% Ampacet |
| | | | | Process aid 10919 |
| 4 | 93% Surlyn 1803 | 93% Ethylene vinyl | 98% Dowlex 2036G | 62% Dowlex 2036G |
| | 5% Ampacet UV | acetate | 1% Ampacet UV | 35% Ethylene vinyl |
| | 2% Ampacet | 5% Ampacet UV | 10561 | acetate |
| | Process Aid | 2% Ampacet | 1% Ampacet | 1% Ampacet UV |
| | | Process Aid | Process aid | 2% Ampacet |
| | | | | Process aid |
| 5 | 93% Surlyn 1803 | None | 98% Dowlex 2036G | 62% Dowlex 2036G |
| | 5% Ampacet UV | | 1% Ampacet UV | 35% Ethylene vinyl |
| | 2% Ampacet | | 1% Ampacet | acetate |
| | Process Aid | | process aid | 1% Ampacet UV |
| | | | | 2% Ampacet |
| | | | | Process aid |
| 6 | 93% Surlyn 1803 | None | 85% Petrothene | 77% Petrothene |
| | 5% Ampacet UV | | NA324-009 | NA324-009 |
| | 2% Ampacet | | 13% Ethylene vinyl | 20% Ethylene vinyl |
| | Process Aid | | acetate | acetate |
| | | | 1% Ampacet UV | 1% Ampacet UV |
| | | | 10561 | 10561 |
| | | | 1% Ampacet | 2% Ampacet |
| | | | Process aid | Process aid 10919 |

The laminate films from Table I were coated on the adhesive layer with adhesive S8072, which is an acrylic-based adhesive sold by Avery Dennison Corporation and which also is used in the vinyl overlaminate sold by Avery Dennison Corporation under the trade name DOL 2060. The adhesive-coated films were laminated to a non-PVC print film sold by Avery Dennison Corporation as Truelmpact (TMP) 7000 series, which has S-8072 adhesive on its back surface. One segment of overlaminated print film was applied on a surface coated automotive panel using a soft squeegee to ensure that an intimate contact was made between the graphic laminate and the substrate, then another segment of overlaminated print film was applied on the same panel such that an overlap was formed at the joint area as illustrated in FIG. 5 such that an overlap seam was created. In addition, the seams were made such that they were either parallel to the machine direction of the film or parallel to the cross-direction of the film.

Each laminated panel sample was left at room temperature for at least twenty-four hours before being tested for tunneling to ensure the strong adhesion build-up between film and panel. Tunneling was known to result after temperature cycling as described above.

Tunneling testing was done by placing the samples in an oven that was preheated to 70° C. The samples were left in the oven for at least thirty minutes and were examined for any sign of tunneling. After the initial assessment, the samples were placed in the oven for at least twenty-four hours before a second evaluation. Films were examined with a seam orientation in the machine direction and with a seam orientation in the cross direction, as illustrated in FIG. 10. The extent of tunneling was ranked based on the level of buckling of the film. As indicated in Table II, a ranking of 1 indicates that the film did not lift or buckle when exposed to the temperature swings and a ranking of 5 indicates the worst observations of tunneling with pronounced buckling. The results are shown below in Table II.

TABLE II

| | Seam | Tunneling | Tunneling |
|---|---|---|---|
| Sample ID | Orientation | Comments | Ranking |
| Sample 1 | MD | No tunneling | 1 |
| Sample 1 | CD | No tunneling | 1 |
| Sample 2 | MD | No tunneling | 1 |
| Sample 2 | CD | Slight tunneling | 3 |
| Sample 3 | MD | Shows tunneling | 5 |
| Sample 3 | CD | Shows tunneling | 5 |
| Sample 4 | MD | Shows tunneling | 5 |
| Sample 4 | CD | Shows tunneling | 5 |
| Sample 5 | MD | No tunneling | 1 |
| Sample 5 | CD | Shows tunneling | 5 |
| Sample 6 | MD | Slight tunneling | 3 |
| Sample 6 | CD | Slight tunneling | 3 |

As shown by the results in Table II, tunneling was not observed at the seam of laminate samples (in either the machine direction or cross-direction samples) having ethylene vinyl acetate in the core layer.

### Example II

In this example, Sample 7 had the same formulation and was prepared in the same manner as Sample 1. Sample 7 was compared with commercially-available products for tunneling properties. The commercially-available products are shown in the table below. The Avery Dennison samples, namely DOL 2060, TOL 7060, and PE85, are available from Avery Dennison Corporation. The 3M 8548 Envision Gloss sample is available from 3M. Except for the 3M 8548 Envision gloss sample (which includes an adhesive), each sample was coated with an adhesive before being laminated over Truelmpact (TMP) 7000 (also available from Avery Dennison), which also was coated with the same adhesive. Each laminate was then applied onto a coated metal panel as described in Example I. The results are provided in Table III using the same ranking scale provided above.

TABLE III

| | Sample | Tunneling | Tunneling |
|---|---|---|---|
| Sample | Description | Comments | Rank |
| Sample 7 | 3-layer Polyolefin/ | No tunneling in both | 1 |
| | EVA core | orientations | |
| Avery Dennison | Overlaminate/ | No tunneling in both | 1 |
| DOL 2060 | PVC | orientations | |
| 3M 8548 | Overlaminate/ | No tunneling in both | 1 |
| Envision Gloss | Polyurethane | orientations | |
| Avery Dennison | Overlaminate/ | Tunnels in both | 5 |
| TOL 7060 | Polyolefin | orientations | |
| Avery Dennison | Polyolefin | Tunnels in both | 5 |
| PE85 | (polyethylene) film | orientations | |

As shown from the results in Table III, DOL 2060 and 3M 8548 Envision Gloss (which is a polyurethane film) show similar performance in tunneling as Sample 1. However, the samples of PE 85 and TOL 7060 both show severe tunneling under the testing conditions.

Comparison testing between an overlaminate of the present invention and commercially-available products was also done to determine modulus and tensile properties. The modulus of each film was tested using Dynamic Mechanical Analysis from TA Instruments, and the samples were scanned from −50° C. to 150° C. at 1 Hz. The modulus results are shown in Table IV below and, as shown, the samples that showed no tunneling have a lower modulus at 70° C. as compared to the samples that showed tunneling.

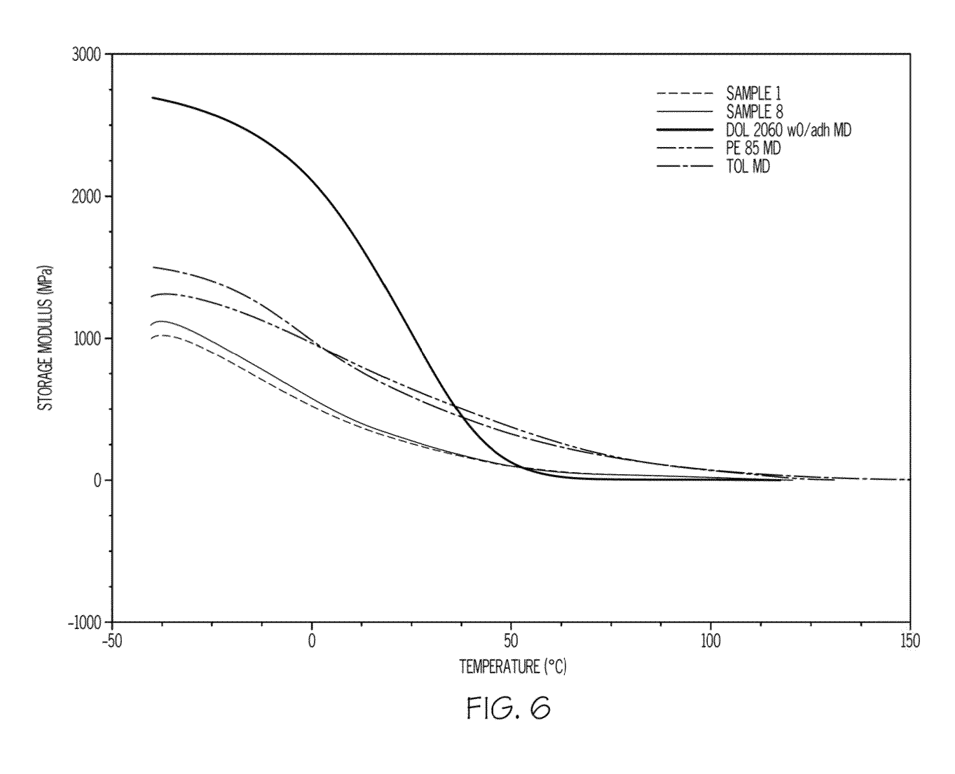

In addition, the tensile properties of those films were measured at room temperature and at 70° C. using Instron equipped with a temperature control chamber. The results are also shown in Table IV below. From these results, it may be observed that the samples that did not result in tunneling had a lower a lower modulus at 70° C. than the samples that did result in tunneling. In addition, a digital mechanical analysis (DMA) curve was prepared as shown at FIG. 6, from which it may be observed (along with the data herein) that if the modulus is within an acceptable range at 70° C. the film does not tunnel.

TABLE IV

| | | Modulus | | | |
|---|---|---|---|---|---|
| | | at Room | | Modulus at | |
| | | Temperature | | 70° C. | |
| | Film | CD | MD | CD | MD |
| Sample | Description | (PSI) | (PSI) | (PSI) | (PSI) |
| Avery | PVC | 47,825 | 71,381 | 283 | 883 |
| Dennison | | | | | |
| DOL 2060 | | | | | |
| Avery | Polypropylene | 44,855 | 78,168 | 12,264 | 15,998 |
| Dennison | Based film | | | | |
| TOL 7060 | | | | | |
| Avery | Blend of | 10,2781 | 98,291 | 31.422 | 20,647 |
| Dennison | HDPE/LLDPE | | | | |
| PE 85 | | | | | |
| Sample 1 | Polyolefin/ | 28,210 | 30,324 | 6,198 | 5,389 |
| | EVA blend | | | | |
| 3M 8548 | Polyurethane | 51,203 | 31,804 | 9,757 | 8,146 |
| Envision | film | | | | |
| Gloss | | | | | |

### Example III

In this example, film structures were created using the same process as described in to Example I but using a five-layer feedblock and five extruders. The formulation for each extruder is provided in Table V below, and the layers of the film were positioned in the order provided in the table. The films of this example were created to increase the modulus at room temperature while maintaining a low temperature modulus at elevated temperatures.

TABLE V

| | Skin Layer A | Core Layer B | Core Layer C | Core Layer D | Adhesive Layer E |
|---|---|---|---|---|---|
| Sample | (10%) | (10%) | (60%) | (10%) | (10%) |
| 8 | 93% Surlyn 1803 | 73% Petrothene | 73% Petrothene | 73% Petrothene | 62% Petrothene |
| | 5% Ampacet UV | NA324-009 | NA324-009 | NA324-009 | NA324-009 |
| | 2% Ampacet | 25% Ethylene | 25% Ethylene | 25% Ethylene | 35% Ethylene |
| | Process Aid | vinyl acetate | vinyl acetate | vinyl acetate | vinyl acetate |
| | | 1% Ampacet | 1% Ampacet | 1% Ampacet | 1% Ampacet |
| | | UV 10561 | UV 10561 | UV 10561 | UV 10561 |
| | | 0.5% Ampacet | 0.5% Ampacet | 0.5% Ampacet | 0.5% Ampacet |
| | | Process aid | Process aid | Process aid | Process aid |
| | | 0.5% FRC-2005 | 0.5% FRC-2005 | 0.5% FRC-2005 | 0.5% FRC-2005 |
| 9 | 93% Surlyn 1803 | 73% Dow | 73% Dow | 73% Dow | 62% Dow |
| | 5% Ampacet UV | DMTA -8904 | Petrothene | DMTA -8904 | DMTA-8904 |
| | 2% Ampacet | NT 7 HDPE | NA324-009 | NT 7 HDPE | NT 7 HDPE |
| | Process Aid | 25% Ethylene | 25% Ethylene | 25% Ethylene | 35% Ethylene |
| | | vinyl acetate | vinyl acetate | vinyl acetate | vinyl acetate |
| | | 1% Ampacet | 1% Ampacet | 1% Ampacet | 1% Ampacet |
| | | UV 10561 | UV 10561 | UV 10561 | UV 10561 |
| | | 0.5% Ampacet | 0.5% Ampacet | 0.5% Ampacet | 0.5% Ampacet |
| | | Process aid | Process aid | Process aid | Process aid |
| | | 0.5% FRC-2005 | 0.5% FRC-2005 | 0.5% FRC-2005 | 0.5% FRC-2005 |
| 10 | 93% Surlyn 1803 | 73% Dow | 73% Dow | 73% Dow | 62% Dow |
| | 5% Ampacet UV | DMTA -8904 | DMTA -8904 | DMTA -8904 | DMTA-8904 |
| | 2% Ampacet | NT 7 HDPE | NT 7 HDPE | NT 7 HDPE | NT 7 HDPE |
| | Process Aid | 25% Ethylene | 25% Ethylene | 25% Ethylene | 35% Ethylene |
| | | vinyl acetate | vinyl acetate | vinyl acetate | vinyl acetate |
| | | 1% Ampacet | 1% Ampacet | 1% Ampacet | 1% Ampacet |
| | | UV 10561 | UV 10561 | UV 10561 | UV 10561 |
| | | 0.5% Ampacet | 0.5% Ampacet | 0.5% Ampacet | 0.5% Ampacet |
| | | Process aid | Process aid | Process aid | Process aid |
| | | 0.5% FRC-2005 | 0.5% FRC-2005 | 0.5% FRC-2005 | 0.5% FRC-2005 |

The films of Example III were coated with adhesive S8072, available from Avery Dennison Corporation, as described in Example I. The samples were then tested for tunneling using the test procedure described in Example I. The results are reported in Table VI below, and it was observed that the addition of ethylene vinyl acetate to the core layer and the adhesive layer minimizes tunneling during the thermal cycling of the laminate. However, in some embodiments, suitable results with minimal or no tunneling may be obtained by the inclusion of ethylene vinyl acetate only in the core layer.

TABLE VI

| | Tunneling Comments | Tunneling | Burn Test |
|---|---|---|---|
| Sample | (MD and CD) | Rank | (EN13501-1) |
| 8 | Negligible in CD and | 2 | Pass |
| | MD orientations | | |
| 9 | No tunneling in CD and | 1 | Pass |
| | MD orientations | | |
| 10 | No tunneling in CD and | 1 | Pass |
| | MD orientations | | |

The films of Example III were also tested for flammability based on European Standard EN 13501-1. For this testing, a strip measuring one inch strip by 6 inches was laminated to an aluminum panel, and the laminated strip was exposed to a burner for 30 seconds and then removed. A laminate was considered a pass if the entire laminate did not burn completely or if the flame did not grow larger than 6 inches. As indicated in Table VI above, all of the samples of Example III passed the burn test.

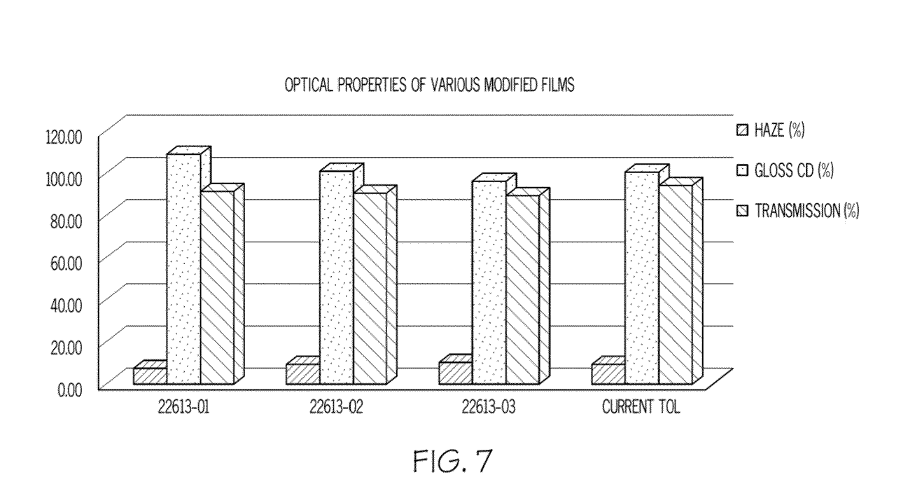

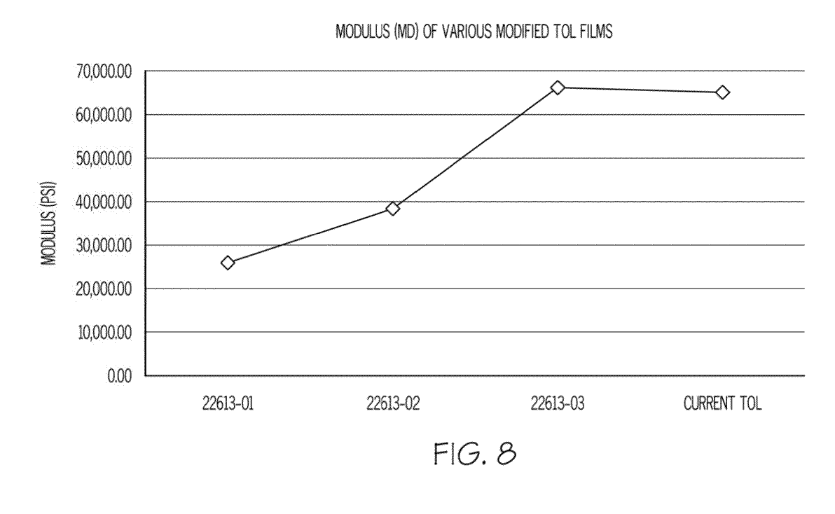

The optical and tensile properties of the overlaminate films of Example III also were compared with the current overlaminate product available from Avery Dennison as TOL 7060. The results are shown in FIGS. 7 and 8, wherein Sample 22613-01 correlates to Sample 8, Sample 22613-02 correlates to Sample 9, Sample 22613-03 correlates to Sample 10, Current TOL represents the commercially-available TOL 7060 product of Avery Dennison Corporation. From these results, it is apparent that the use of high density is suitable for some embodiments of the present invention and results in sufficient stiffness. In addition, for certain applications, medium density polyethylene, by itself, may not provide suitable stiffness in the film.

### Example IV

In this example, film structures were extruded in the same manner as described above for Example I, and the formulation for each layer is provided in Table VII below. The Tg of Topas 9903 D-10 is 35° C. and the Tg of Topas 9506F-04 is 65° C.

TABLE VII

| Sample | Skin Layer (A) | Core Layer (C) | Adhesive Layer (D) |
|---|---|---|---|
| 11 | 100% Surlyn 1803 | 100% Huntsman LDPE 1017 | 100% Huntsman LDPE 1017 |
| 12 | 100% Surlyn 1803 | 25% Topas 9903 D-10 | 25% Topas 9903 D-10 |
| | | 75% Petrothene NA324-009 | 75% Petrothene NA324-009 |
| 13 | 100% Surlyn 1803 | 25% Topas 9903 D-10 | 25% Topas 9903 D-10 |
| | | 25% Ethylene vinyl acetate | 25% Ethylene vinyl acetate |
| | | 50% Huntsman LDPE 1017 | 50% Huntsman LDPE 1017 |
| 14 | 100% Surlyn 1803 | 50% Topas 9903 D-10 | 50% Topas 9903 D-10 |
| | | 50% Huntsman LDPE 1017 | 50% Huntsman LDPE 1017 |
| 15 | 100% Surlyn 1803 | 25% Topas 9506F-04 | 25% Topas 9903 D-10 |
| | | 75% Huntsman LDPE 1017 | 75% Huntsman LDPE 1017 |
| 16 | 100% Surlyn 1803 | 25% Topas 9506F-04 | 25% Topas 9903 D-10 |
| | | 25% Ethylene vinyl acetate | 25% Ethylene vinyl acetate |
| | | 50% Huntsman LDPE 1017 | 50% Huntsman LDPE 1017 |
| 17 | 100% Surlyn 1803 | 50%Topas 9506F-04 | 50% Topas 9903 D-10 |
| | | 50% Huntsman LDPE 1017 | 50% Huntsman LDPE 1017 |
| 18 | 100% Surlyn 1803 | 25% Topas 9506F-04 | 25% Topas 9506F-04 |
| | | 25% Topas 9903D-10 | 25% Topas 9903D-10 |
| | | 50% Huntsman LDPE 1017 | 50% Huntsman LDPE 1017 |
| 19 | 100% Surlyn 1803 | 15% Topas 9506F-04 | 15% Topas 9506F-04 |
| | | 15% Topas 9903D-10 | 15% Topas 9903D-10 |
| | | 70% Huntsman LDPE 1017 | 70% Huntsman LDPE 1017 |

Each film was adhesive coated with S8072, an adhesive sold by Avery Dennison Corporation, and the films were then laminated to a Truelmpact 7000 print layer, which is sold by Avery Dennison Corporation. The samples were mounted onto a coated automotive panel substrate such that an overlap was created between two segments of overlaminated print film. The overlaminates were tested for tunneling as described above and mechanical properties were determined using Instron as described in previous examples. The results are provided in Table VIII below.

TABLE VIII

| | | | MD Modulus | |
|---|---|---|---|---|
| | | | at room | |
| | Tunneling | Tunneling | temperature | Film |
| Sample | Comments | Rank | (PSI) | Gloss |
| 11 | Tunnels in both | 5 | N/A | N/A |
| | orientations | | | |
| 12 | No tunneling in | 1 | 59,530 | 98.3 |
| | both orientations | | | |
| 13 | No tunneling in | 1 | 31,681 | 99.2 |
| | both orientations | | | |
| 14 | No tunneling in | 1 | 65,593 | 50.9 |
| | both orientations | | | |
| 15 | No tunneling in | 1 | 57,361 | 77.3 |
| | both orientations | | | |
| 16 | No tunneling in | 1 | 58,037 | 86.0 |
| | both orientations | | | |
| 17 | No tunneling in | 1 | 149,833 | 95.6 |
| | both orientations | | | |
| 18 | No tunneling in | 1 | 117,733 | 89.6 |
| | both orientations | | | |
| 19 | No tunneling in | 1 | 70,284 | 91.8 |
| | both orientations | | | |

From the results in Table VIII, it was observed that including amorphous olefin copolymers having a Tg above 25° C. and below 70° C. improved the room temperature tensile properties of the film, which are essential for handling during application and also reduce or eliminate tunneling when the film is exposed to elevated temperature conditions like 70° C. Without intending to be bound by theory, it is believed that the reduction of tunneling is due to significant modulus decrease resulted from softening of the amorphous olefin copolymer 70° C.

The modulus values measured at room temperature and at 70° C. of certain formulations from Example III and Example IV reported below in Table IX.

TABLE IX

| | Modulus @ | Modulus @ | Tunneling |
|---|---|---|---|
| Sample | RT (PSI) | 70° C. (PSI) | Observed |
| 12 | 60,870 | 5246 | None |
| 13 | 52,359 | 2194 | None |
| 14 | 51,947 | 1429 | None |
| 18 | 130,704 | 1,456 | None |
| 19 | 73,881 | 3,336 | None |
| 9 | 38,593 | 5,753 | None |

As shown in the results in Table IX, the films tested did not show any tunneling. Notably, the modulus at 70° C. for each of these films was significantly lower than the corresponding modulus for films that demonstrated tunneling in other examples.

In some embodiments, overlaminates of the present invention may also include or have applied thereto a top coating. Such top coatings may be one layer and applied to the overlaminate, such as adjacent to the skin layer. Top coatings may be comprised of any suitable materials. In certain embodiments, top coatings may comprise polymers containing acrylic, ester, urethane, or blends thereof. The top coating may enhance the adhesion at the seaming area of overlapping segments (as illustrated in FIG. 5 and FIG. 9), i.e., the adhesion between the adhesion on the surface of the overlaminate. In addition, any additional decals or materials may be readily adhered to the top coating, which, in some embodiments, may have better adhesion to such items as compared with the skin layer. For example, some advertisements may include an overlaminate and an advertiser may wish to adhere additional information to the advertisement, such as sign-cut phone number or logo. In such instances, materials conveying the additional information, called an overpost or overposting, may be adhered to the top coating. The following Example V provides additional disclosure of illustrative embodiments of this nature.

### Example VI

Two different rolls of films made in were used in this example. For a first roll, the skin layer (surlyn) was prepared according to the formulation of Sample 9 and was then corona treated to 50-52 dynes. Then, the film was coated with a top coating, which is used particularly in the product Fasson 2 Mil Clear BOPP TC available from Avery Dennison Corporation (Spec#78148). For the second roll, the film was prepared using the formulation of Sample 8. Then, the film was passed through a flame treatment at 100 ft/min to treat the skin (surlyn) layer, and the surface energy of the treated film was measured to be 58 dynes. Both the coated and flame-treated films were then coated with pressure sensitive adhesive to the adhesive layer and laminated with liner. The adhesive and liner used were the same as those used in Avery Dennison's commercially available D0L2060 gloss products. Samples were taken from both rolls and laminated with True Impact (TMP) 7000 materials, available from Avery Dennison Corporation.

Each sample was then placed on the roof and side panels of a car to create an overlap as illustrated in FIG. 5. The samples on the roof were evaluated for tunneling and the samples on the side panels were washed with high pressure hoses for at least one minute and evaluated for delamination at the seaming area. Two control samples, namely DOL 2060 gloss and TOL 7060, both sold by Avery Dennison Corporation, were also used, and these samples were neither coated nor flame treated. The car was used under normal driving conditions and was always parked outdoors. The highest outdoor temperature during the test was 100° F., but the actual highest temperature of the on the car roof may have exceed 160° F. The results are shown in Table X below.

TABLE XI

| | | | Overlap |
|---|---|---|---|
| | | | delamination |
| | | Tunneling | at seaming |
| | Location | Ranking | area after |
| Sample Description | on Car | after 4 weeks | pressure wash |
| TC-Coated Overlaminate | Roof | 1 | NM |
| TC-Coated overlaminate | Side | NM | No |
| | panel | | |
| Flame-treated overlaminate | Roof | 1 | NM |
| Flame-treated overlaminate | Side | NM | No |
| | panel | | |
| Overlaminate | Roof | 1 | NM |
| (no coating/flame treatment) | | | |
| Overlaminate | Side | NM | Yes |
| (no coating/flame treatment) | panel | | |
| TOL 7060 | Roof | 5 | NM |
| TOL 7060 | Side | NM | Yes |
| | panel | | |
| DOL 2060 | Roof | 1 | NM |
| DOL 2060 | Side | NM | No |
| | panel | | |

*NM indicates not measured

It was observed that the adhesion of an the seaming area of overlap film to the surface of the overlaminate film was improved by either coating the film with TC coating or flame treatment, and such coatings did not affect the resistance of the film to tunneling. Other coatings that may be suitable include, without limitation, coatings such as Neorez waterborne coatings sold by DSM and acrylic coatings sold under the tradename NeoCryl by DSM.

Embodiments of the present invention may used for any suitable purpose. In some embodiments, films of the present invention may be used as overlaminates for signs, posters, banners, vehicle signage applications, and other printed materials. As described above, embodiments of overlaminates of the present invention may be used on materials for indoor and/or outdoor display. In addition, as demonstrated by the examples above, films of the present invention may desirably avoid tunneling effects in some embodiments.

In addition, films of the present invention may be prepared using any suitable process. By way of example, films of the present invention may be prepared using cast film processes, blown film processes, and extrusion and coextrusion processes.

These and other modifications and variations to the present invention may be practiced by those of ordinary skill in the art without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

What is claimed is:

1. An overlaminate film comprising:
a skin layer comprising an abrasion resistant material,
a core layer comprising a blend of one or more semicrystalline polymers and ethylene vinyl acetate, and
an adhesive layer,
wherein the core layer is positioned between the skin layer and the adhesive layer.

2. The film of claim 1 wherein the core layer comprises about 5 to about 95 percent by weight semicrystalline polymers.

3. The film of claim 1 wherein the core layer comprises about 5 to about 95 percent by weight ethylene vinyl acetate.

4. The film of claim 1 wherein the core layer comprises about 5 to about 95 percent by weight semicrystalline polymers and about 5 to about 95 percent by weight ethylene vinyl acetate.

5. An overlaminate film comprising:
a skin layer comprising an abrasion resistant material,
a core layer comprising (i) one or more of an amorphous olefin polymer having either a glass transition temperature (Tg) in the range of about 20° C. to about 70° C. (including each intermittent value therein), and/or a semicrystalline olefin copolymer having a melting point in the range of about 20° C. to about 70° C. including each intermittent value therein), and (ii) a polyolefin, and
an adhesive layer,
wherein the core layer is positioned between the skin layer and the adhesive layer.

6. The film of claim 5 wherein the core layer comprises about 5 to about 100 percent by weight amorphous olefin copolymer.

7. The film of claim 5 wherein the core layer comprises about 0 to about 95 percent by weight polyolefin.

8. The film of claim 5 wherein the core layer comprises about 20 to about 100 percent by weight amorphous olefin copolymer and about 0 to about 80 percent by weight polyolefin.

9. The film of claim 5 wherein the core layer is a multilayer core layer.

10. The film of claim 5 wherein the core layer comprises high density polyethylene.

11. The film of claim 5 wherein the core layer comprises medium density polyethylene.

12. The film of claim 5 wherein the core layer comprises a blend of high density polyethylene and medium density polyethylene.

13. The film of claim 8 wherein the amorphous olefin copolymer comprises cyclic olefin copolymer.

14. The film of claim 5 wherein the film does not experience tunneling when exposed to increased temperatures in the range up to 100° C.

15. The film of claim 5 wherein the film does not experience substantial tunneling when exposed to increased temperatures in the range up to 100° C.

16. The film of claim 5 wherein the film further comprises a top coating.

17. The film of claim 14 wherein the top coating is comprised of a urethane coating.

18. The film of claim 14 wherein the top coating is comprised of an acrylic coating.

19. The film of claim 14 wherein the top coating is comprised of an ester coating.

20. The film of claim 14 wherein the skin layer further comprises one or more matting agents.

21. The film of claim 5 wherein the core layer comprises one or more of an ultraviolet (“UV”) light stabilizer, free radical scavengers, a process aid, a flame retardant, and a heat stabilizer.

22. The film of claim 5 wherein the skin layer comprises one or more of an ultraviolet (“UV”) light stabilizer, free radical scavengers, a process aid, a flame retardant, and a heat stabilizer.

23. The film of claim 5 wherein the adhesive layer comprises one or more of an ultraviolet (“UV”) light stabilizer, free radical scavengers, a process aid, a flame retardant, and a heat stabilizer.

24. The film of claim 5 wherein the film is substantially free of polyvinyl chloride (PVC).

25. The film of claim 5 wherein the film is free of polyvinyl chloride (PVC).

26. The film of claim 1 wherein the core layer comprises three layers, wherein a middle core layer is disposed between and immediately adjacent to two outer core layers, wherein the middle core is a blend of medium density polyethylene with ethylene vinyl acetate, and each outer core layer is a blend of blend of high density polyethylene and ethylene vinyl acetate.

27. The film of claim 5 wherein the film is applied to a substrate using an adhesive, wherein at least two segments of the film overlap, and wherein the film does not experience substantial tunneling when exposed to increased temperatures in the range up to 100° C.

28. The film of claim 5 wherein the film further comprises an adhesive located upon the adhesive layer.

29. The film of claim 28 wherein the film further comprises a release liner, wherein the adhesive is disposed between the adhesive layer and the release liner.

30. The film of claim 5 wherein the modulus of the film when measured at 70° C. is less than about 15,000 psi.

31. The film of claim 1 wherein the core layer comprises about 25 percent or more by weight ethylene vinyl acetate.

32. The film of claim 1 wherein the core layer comprises about 25 percent by weight ethylene vinyl acetate.

33. The film of claim 1 wherein the semicrystalline olefin copolymer comprises ethylene-propylene copolymer.

34. The film of claim 1 wherein the core layer comprises at least about 13 percent by weight ethylene vinyl acetate.
